(19) United States
(12) Patent Application Publication
(10) Pub. No.: US 2005/0103519 A1
(43) Pub. Date: May 19, 2005

(54) Low loss superconducting cable in conduit conductor

(76) Inventors: Timothy A. Brandsberg, Goode, VA (US); Robert R. Batchelder, Lynchburg, VA (US); Charles M. Weber, Forest, VA (US); Vladimir Karasik, Forest, VA (US)

Correspondence Address: BWX TECHNOLOGIES, INC.;LAW DEPARTMENT - INTELLECTUAL PROPERTY, 91 STIRLING AVENUE, (MAIL STATION BWO11E), BARBERTON, OH, 44203-0271, US

(21) Appl. No.: 10/716,210

(22) Filed: Nov. 18, 2003

(51) Int. Cl. H01B 12/00

(52) U.S. Cl. 174/125.1

(57) ABSTRACT

A cable in conduit superconductor. The superconductor is formed from bundles of superconducting strands made of superconductor filaments, copper, and a layer of electrical resistant material. The superconductor strands are organized around a solid copper central strand, and a plurality of such wires are organized within a circular stainless steel foil, leaving a spiral gap in the middle for liquid coolant to flow. This configuration is then placed within a conduit tubing and compressed for stability.

### FIELD AND BACKGROUND OF INVENTION

The present invention relates generally to the field of superconductivity and in particular to a new and improved superconducting cable in a conduit with a special geometry, added materials, and arrangement that reduces hysteresis, eddy current, and AC losses and improves magnet stability.

A superconducting system is disclosed in a prior patent U.S. Pat. No. 6,112,531, the entire disclosure of which is hereby incorporated by reference. The invention disclosed herein enhances the operation of the system disclosed in U.S. Pat. No. 6,112,531.

A conductor's conductivity and resistivity is related to the motion of its free electrons. Electrical current results from the movement of electrons through a material. Electrical resistance arises because electrons propagating through the material are scattered due to deviations caused by impurities in the material or lattice vibrations. Atoms and associated nuclei in a lattice structure can become attracted to a passing electron, and the attraction between the electron and a positive ion distorts the crystal structure, resulting in vibrational distortions of the crystal lattice.

Superconductivity is a basic property of particular materials that causes them, when cooled below a critical temperature level Tc, to lose all resistance to the flow of electrons. Sufficiently low temperatures minimize the vibrational energy of individual atoms in the material's crystal lattice. Below the critical temperature level Tc, there is no resistance because the scattered electrons move freely through the material, without encountering impedance due to vibrational distortions. Superconductors are also able to exclude magnetic fields up to a critical field Hc, (in the case of Type II superconductors, up to a critical field Hc1, where superconductivity decreases until it is destroyed at a higher critical field Hc2). As a result, superconductors allow lossless electrical conduction. The conductor is said to quench when it loses its superconducting properties either because its temperature exceeds the critical temperature Tc, or because the applied magnetic field exceeds the critical field Hc.

Two techniques can be used to cool a superconducting cable down to the temperature necessary for the superconduction; bath cooling in which the whole coil is immersed in a bath of a cooling medium; and forced cooling in which a cooling medium is pressed through the spaces between the wire bundles and the ropes (matrix cooling) and/or through cooling channels built into the cable (tubular conductor cooling). Cables intended to be matrix cooled are necessarily enclosed in a gas-tight case, while cables that are to be bath cooled preferably have no case.

Generally, superconductors can be useful in electrical transmission lines because they can allow lossless electrical conduction and can carry current densities many times greater than traditional copper wires. Furthermore, electrical cables are often placed in conduit or duct for protection from both physical and environmental abuse. In underground installation, conduit protects cable from shifting rocks and damage from shovels or mechanical equipment. Cable that is in conduit can easily be replaced or upgraded because the cable can simply be pulled out of the conduit.

### SUMMARY OF INVENTION

The present invention is drawn to a superconducting cable in conduit conductor.

Accordingly, one aspect/object of the invention is to provide an improved superconductor that overcomes the problems associated with prior superconductors.

It is a further object to provide a geometry and form for a superconductor that can resist many common types of deformations due to directional forces as well as displacement of single superconductor strands that could precipitate quench.

It is another object of the present invention to significantly reduce or prevent large circulating eddy currents that may disrupt conducting in a superconductor and to reduce the losses associated with a changing magnetic field.

Another object of the invention is to increase the amount of void space within the superconductor so as to allow a sufficient amount of liquid coolant to enhance the thermal capacity and to expel heat and maintain superconductor functionality in light of heat production from friction or eddy currents.

Accordingly, a superconducting cable in conduit conductor is provided, having multiple stages of cable, mechanically locked into one rectangular position, comprised of superconductor strands, nickel coating, stainless steel foil, and conduit, in such geometric form that supports fifty-two percent void fraction within the conductor.

The various features of novelty that characterize the invention are pointed out with particularity in the claims annexed to and forming part of this disclosure. For a better understanding of the present invention, and the operating advantages attained by its use, reference is made to the accompanying drawings and descriptive matter, forming a part of this disclosure, in which a preferred embodiment of the invention is illustrated.

### BRIEF DESCRIPTION OF THE DRAWINGS

In the accompanying drawings, forming a part of this specification, and in which reference numerals shown in the drawings designate like or corresponding parts throughout the same:

FIG. 1 is a cross-section geometry of an exemplary superconductor strand that may be used in the present invention.

FIG. 2 is an exemplary view of three stages of the cable configuration according to the present invention.

FIG. 3 is a flow chart of a method for assembling a cable within a conduit according to the present invention.

FIG. 4 is an exemplary view of a cable in conduit superconductor.

FIG. 5 is a perspective view of the invention cable.

### DESCRIPTION OF THE PREFERRED EMBODIMENTS

The electromagnetic behavior of a conductor is dependent on its geometry. Superconducting cables are used for the winding of coils that are intended for the excitation of very strong electromagnetic fields, whereby an electromagnetic field interacts with mechanical vibrations of ionic structure in a conducting medium (e.g., metal) in the presence of a constant magnetic field. On exciting magnetic coils, forces corresponding to the vectorial product of the exciting current and the magnetic induction act on the current conductors. These forces are directional and can cause a deformation of the conductors' cross section and the windings' cross section, as well as a change in the relative position of adjacent conductors. These deformations and changes of position can further cause a decrease in the contact pressure between neighboring conductors and/or a relative displacement of neighboring conductors. Both phenomena are particularly disadvantageous for a superconducting cable.

The forces and the deformations caused thereby can combine to produce a directional force on the inner wall of the casing, which can lead to an elastic deformation of the casing. For windings with tightly packed cable casings, the deformation forces of the cases are additive in the direction of the force, so that not only the associated Lorenz force, but in addition the mechanically transmitted deformation of the casing, acts on the individual cable.

Another difficulty with superconductors is maintenance of a sufficiently low transition temperature. During the relative displacement of adjacent conductors, heat can be generated from the resultant friction, which causes a small local rise in temperature and which is particularly disadvantageous at the operating temperature of superconducting cables.

Another effect of the forces is the potential to increase the contact force and area of the strands, which can reduce interstrand resistance and increase eddy currents and heating during a change in the applied field.

The present invention relates to a forced cooling configuration where a cable is enclosed in a tube and the tube is reduced to lock the cable within. This arrangement may also be referred to as Cable In Conduit Conductor (“CICC”). Typically, this type of conductor utilizes several stages of cabling with sufficient conduit reduction to result in an internal volume with 20 to 40% void for the coolant to flow. It has been suggested that wires and stabilizing sheets that make up the cable could be soldered or fusion bonded at the points of contact between wires to form a matrix. This matrix would respond to magnetic forces in an elastic fashion, thus preventing quench due to sudden conductor movement, but would still have sufficient void space for adequate coolant. However, such intimate physical contact could result in low electrical resistance between superconducting strands, resulting in large eddy currents that would cause conductor instability.

Eddy currents are closed loops of induced currents circulating in planes perpendicular to the magnetic flux. They normally travel parallel to the coil's winding and parallel to the surface. Eddy currents flowing at any depth produce magnetic fields that oppose the primary field, thus reducing the net magnetic flux and causing a decrease in current flow as depth increases. Large eddy currents flowing along one superconducting strand and crossing over to another superconducting strand for a return to another point of contact between these same two strands can disrupt conduction. If the contact resistance between the two strands is low, the current can be sufficiently high to exceed the critical current handling capacity of one of the strands.

To reduce eddy current heating within a superconducting cable, various materials with high electrical resistance have been proposed and utilized. Materials considered include nickel, nickel-iron and chromium plating, oxide coatings, and metal foil wrappings. Total insulation between these conductor strands is not desirable since current re-distribution is needed if one conductor strand was to quench and become resistive.

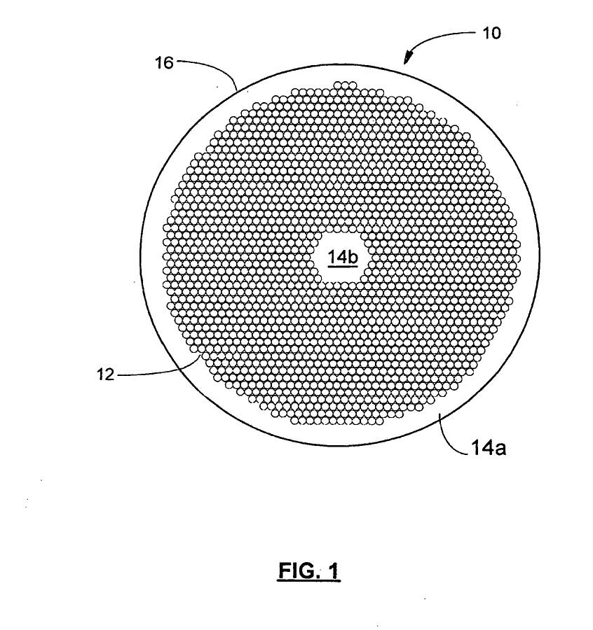

Referring now to the drawings, in which like reference numerals are used to refer to the same or similar elements, FIG. 1 shows the cross-section geometry of an exemplary superconductor strand 10 that may be used in the present invention. Type II superconductor alloys such as Niobium—Titanium (“NbTi”) are favorable superconductors because they are ductile, which allows forming, and they reach higher transition temperatures and higher critical fields before their superconductivity is destroyed. Niobium—Titanium can be used to make coil windings that can withstand high magnetic fields.

Coils can be constructed by embedding a large number (two to three hundred) of fine filaments 12 (˜20 microns) in a copper matrix comprised of an outer portion 14a and possibly an inner portion 14b. The presence and size of the inner portion 14b depends upon whether it is needed to meet the preferred copper to superconductor ratio of 2.9:1 of the cable 22. The fine filaments 12 are advantageous because current flows only within a skin-depth of the surface of a superconductor. The solid copper provides mechanical stability and provides a path for the large currents and reduced heating in case the superconductivity is lost. An exemplary superconducting strand may comprise Niobium—Titanium filaments 12 formed into a wire surrounded by oxygen-free copper 14a with a residual resistivity ratio, RRR, of 70 or greater, which achieves a critical current of 121 amps at a magnetic field of 5 Tesla and a temperature of 4.22K.

The Nb—Ti filaments 12 are stabilized by the copper 14 in each superconductor wire as well as by separate copper wires 18 that are co-wound to form the sub-cable 22. The amount of copper in the overall (final) cable cross section is preferably 2.9 times that of the superconducting material. The total amount of copper is selected to reduce the heat generated in the cable after a localized quench of a superconducting strand due to the current redistributing around the quenched superconductor.

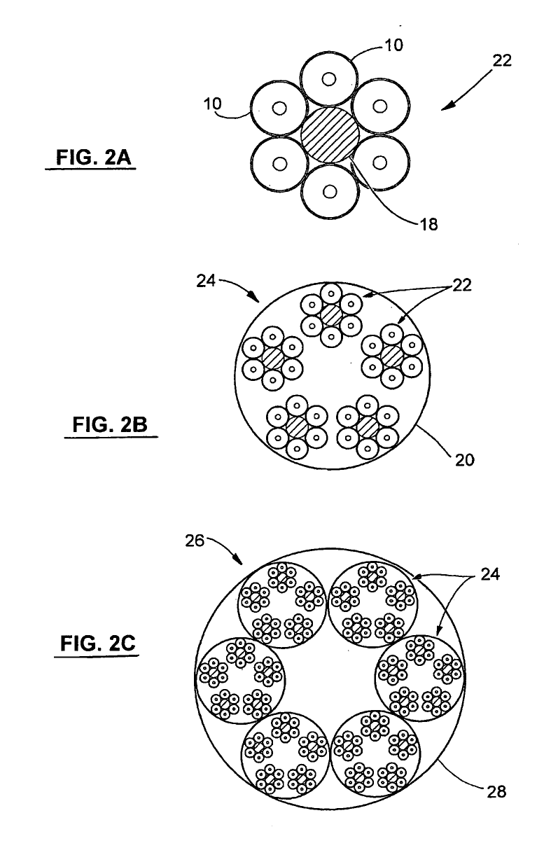

An exemplary embodiment of the present invention may also include a layer of nickel 16 plated upon both the superconducting 10 and plain copper wire strands 18 in the cable for the purpose of inhibiting eddy currents by increasing inter-strand electrical resistance. The resistance is further increased with a partial wrap of stainless steel foil 20 around the second stage sub-cable 24, as depicted in FIG. 2. The increased resistance reduces the potential for eddy current loops forming as the magnetic field changes rapidly.

A plurality of superconducting strands 10 that make up the first stage sub-cable bundle 22 offer a stable geometry to prevent the individual superconducting strands 10 from moving under the electromagnetic forces.

FIG. 2 shows an exemplary embodiment of a three-stage cable configuration 26 according to the present invention. A three-stage cable 26 has been selected that is comprised of two hundred ten strands that include one hundred eighty Ni-plated supreconducting strands 10 and thirty Ni-plated solid copper strands 18.

The specific arrangement of the sub-cables has been selected to have a high void fraction in its compressed form. Void fraction is the ratio of the volume taken up by air spaces (i.e., the voids) to the total volume of material or, in other words, the space not occupied by the packed material. High void fractions have a large quantity of coolant and allow freer and more unrestricted flow of liquid or liquid and gas coolant. Through the selection of a cable winding pattern that results in high void fraction, the amount of liquid coolant in contact with the conductor strands 10 can be enhanced. A cable according to the present invention may be cooled by a flow of supercritical helium inside the cable wire matrix. Compaction to the final configuration will result in a cable that is well supported at the strand level, but which will still have a large void fraction, enhancing the amount of coolant that may flow within.

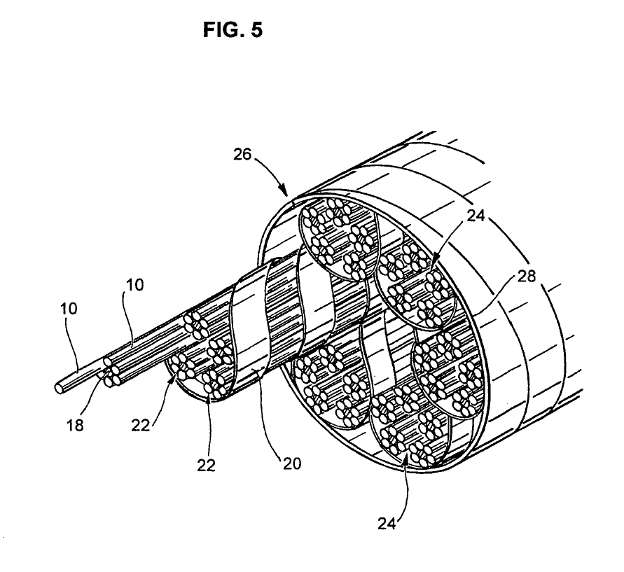

The first stage sub-cable 22 shown in FIG. 2a and FIG. 5 may be comprised of six superconducting strands 10 surrounding a single, solid copper strand 18 with a tight twist pitch of about 12-15 mm. Each superconducting strand 10 may be comprised of a plurality of superconductor filaments 12, a copper matrix 14, and a layer of material 16 that is capable of inhibiting eddy currents as described above for FIG. 1. The superconductor filaments 12 may be comprised of NbTi or similar high critical temperature and high critical field superconductors.

This cable formation mechanically locks the superconductor strands 10 into a very stable configuration. Thus, motion of a superconductor strand 10, which could precipitate a quench of that strand, is prevented. By using a non-superconducting center wire such as copper, each superconducting strand 10 directly touches only two adjacent superconducting strands 10, reducing the potential amount of current redistribution between superconductors within the first stage sub-cable 22 by a factor of one-third. Therefore, the first stage sub-cable 22 may be comprised of more or less than six superconducting strands 10, so long as each strand comes only in contact with each neighboring strand when wrapped around a central non-superconducting wire 18, assuring a stable locked geometry.

The second stage sub-cable 24 shown in FIG. 2b and FIG. 5 may be comprised of five of the first stage sub-cables 22 wrapped with a tight twist pitch of about 38-43 mm. The second stage sub-cable 24 may be wrapped with 6.25 mm wide and 0.025 mm thick 304 stainless steel foil strip 20 spiraled around the bundle with a spiral gap of about 1.3 to 2.6 mm between adjacent helical wraps to allow room for coolant flow. The spiral gap is best seen in FIG. 5. Stainless steel is a material of high electrical resistance and is included to reduce eddy currents that may destabilize the superconductor. The spiral gap within the present configuration also provides adequate space for coolant flow, which is essential for maintaining a temperature below the critical temperature of the superconductor. The second stage sub-cable 24 may also be comprised of more or less than five first stage sub-cables 22 so long as a sufficient spiral gap is maintained for void content upon compression.

The third stage cable 26 shown in FIG. 2c and FIG. 5 may be comprised of six second stage sub-cables 24 wrapped with a tight twist pitch of about 110-120 mm and an over-wrap of stainless steel foil 28 to protect the cable during conduit jacketing operations. The over-wrap also provides dimensional stability. The stainless steel foil 28 provides further prevention of eddy currents and covers one hundred percent of the entire cable. Additionally, the third stage cable 26 may be comprised of more or less than six second stage sub-cables 24 so long as the center spiral gap remains sufficient for void content upon compression.

Although only three stages of sub-cable are illustrated and described it should be understood that more than three stages may be used.

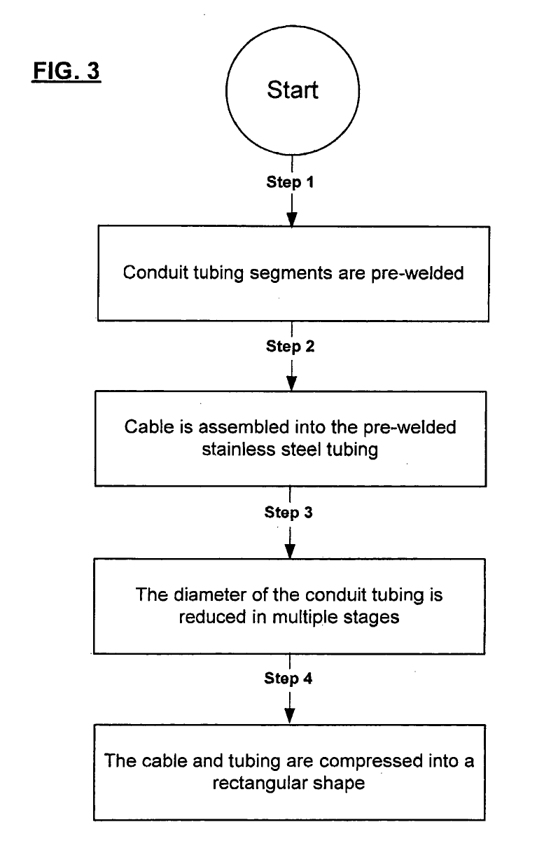

FIG. 3 outlines a method for assembling a cable within a conduit according to the present invention. While there are obviously a number of minor steps that should be readily apparent, such as the placement of each strand or wire, only four major steps are identified by number for the sake of simplicity and brevity. In step 1, the conduit tubing segments are continuously extruded or pre-welded to form long lengths prior to inserting the cable, thus reducing the amount of welding required with the cable inside the tube. In step 2, the cable is assembled into the pre-welded seamless stainless steel tubing. The tubing is initially sized at 11/16 inch OD (outside diameter) with a wall of 0.055 inch thickness to allow low friction when pulling the cable through the tube. In step 3, the diameter of the cable and tubing is reduced in multiple stages. A 1.5:1 (height to width) ratio for the internal dimensions is used to minimize the distortion of the last stage cabling pattern, which may cause damage to the nickel plating and allow an undesirable reduction in strand to strand resistance. The ratio is also implemented to reduce the potential for non-uniform inductance in the various superconducting wires that make up the cable. In step 4 the tubing is compressed by a tubing mill and Turks head to form a conductor with a rectangular configuration. This configuration facilitates winding into a high density magnetic coil. The dimensions of the tubing, combined with a multi-stage diameter reduction are selected to prevent buckling of the conduit walls in the Turks head reduction. If starting with a large tube to form the CICC, the forces required to pull the superconductor cable through are low. However, if this large tube were to be immediately swaged down to the desired rectangular shape, the walls would buckle and collapse into the internal void space. By first reducing the diameter of the tube, a high quality rectangular shape can be produced.

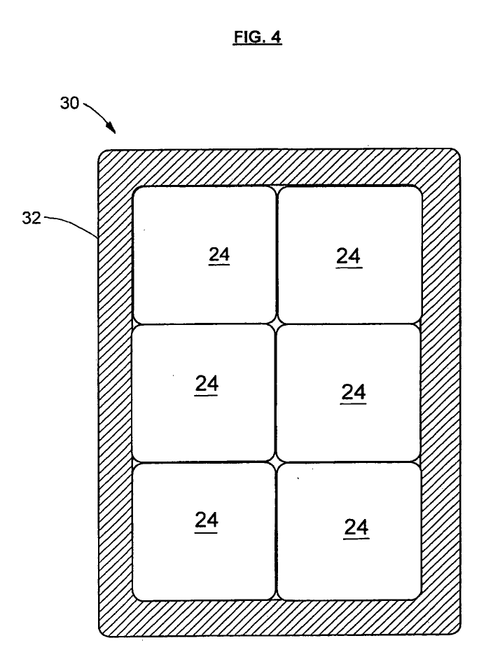

FIG. 4 shows an exemplary cable in conduit superconductor 30 according to the present invention. The figure depicts six second stage sub-cables 24 surrounded by a stainless steel conduit 32. Each second stage sub-cable 24 contains a plurality of copper-jacketed superconducting strands, contained by stainless foil 28. The six second stage sub-cables 24 are pressed together at their points of contact by a surrounding conduit 32 that has been compressed to form a nearly rectangular shape. The rectangular shape was formed by reduction in a tube reducing mill and roll forming in a Turks head as described above for the method of FIG. 3. The described configuration is manufacturable and performs in a manner that meets operating design requirements.

The configuration of a cable with a surrounding conduit reduces the eddy current heating of the cable and assures an abundant heat removal capability for a rapid change in the magnetic fields associated with changes in the stored energy in the magnetic coil. This specific configuration also may minimize damage to the superconductor strands 10 due to forming operations, and may facilitate subsequent winding operations whereby bending is performed with low bending moment.

The specific degree that the cable and conduit is compressed is selected to achieve a void fraction within the CICC of about fifty-two percent. This degree of void fraction assures that enough supercritical helium is located adjacent to the cable strands to immediately begin removal of heat generated by rapid magnetic field transient. By having the helium in the cable at all times, the normal operating helium flow rate is minimized along with the refrigeration system size and pressure drop. By selecting a cabling pattern with a large initial void fraction, the final cable-in-conduit conductor can be well supported by the conduit pressure and still have a large void fraction for liquid coolant.

While specific embodiments and/or details of the invention have been shown and described above to illustrate the application of the principles of the invention, it is understood that this invention may be embodied as more fully described in the claims, or as otherwise known by those skilled in the art (including any and all equivalents), without departing from such principles.

1. A superconducting cable comprising a plurality of individual superconducting wires that are stranded into wire bundles and ropes, wherein the individual wire bundles and the ropes are pressed together at their points of contact by a surrounding conduit that has been compressed to form a nearly rectangular shape.

2. The superconducting cable of claim 1, wherein each of the individual wires is capable of maintaining high densities of current when combined with other of said individual wires.

3. The superconducting cable of claim 1, wherein each of the individual superconducting wires is plated with a material of high electrical resistance.

4. The superconducting cable of claim 3, wherein the individual wires are plated with nickel.

5. The superconducting cable of claim 1, including a non-superconducting wire in each bundle of individual superconducting wires.

6. The superconducting cable of claim 1, wherein the bundles of wires are each a first stage cable and are twisted with a tight twist pitch of about 10-15 mm.

7. The superconducting cable of claim 6, wherein the ropes are ropes or bundles of the first stage cable and are twisted to form a second stage cable with a tight twist pitch of about 30-45 mm.

8. The superconducting cable of claim 7, including a plurality of said ropes twisted together to form a third stage cable with a tight twist pitch of about 100-120 mm.

9. The superconducting cable of claim 1, wherein each of the superconducting wires comprises a multiplicity of superconducting strands in a copper matrix.

10. The superconducting cable of claim 1, wherein the geometry for the superconducting cable provides at least a 50% void fraction for accommodation of a liquid coolant.

11. The superconducting cable of claim 1, wherein the superconducting cable contains at least three stages of sub-cables wherein the first stage includes copper-jacketed superconducting strands with a solid copper central strand, the second stage includes a number of first stage sub-cables surrounded by stainless steel foil with a spiral gap, and the third stage includes a number of second stage sub-cables surrounded by stainless steel foil.

12. A method of making a superconducting cable, comprising:
a. providing a conduit tubing;
b. forming a three stage rope of wires having a first stage including copper-jacketed superconducting strands with a solid copper central strand to form first stage sub-cables, a second stage including a plurality of first stage sub-cables surrounded by stainless steel foil with a spiral gap forming a second stage sub-cable, and the third stage including a plurality of second stage sub-cables surrounded by stainless steel foil;
c. reducing the diameter of the conduit tubing to form a rectangular shape; and
d. compressing the rope into the rectangular shape.
